(19) United States
(12) Patent Application Publication
(10) Pub. No.: US 2024/0391356 A1
(43) Pub. Date: Nov. 28, 2024

(54) POWER STORAGE SYSTEM AND VEHICLE

(71) Applicant: TOYOTA JIDOSHA KABUSHIKI KAISHA, Toyota-shi (JP)

(72) Inventor: Toshio DOKE, Kariya-shi (JP)

(73) Assignee: TOYOTA JIDOSHA KABUSHIKI KAISHA, Toyota-shi (JP)

(21) Appl. No.: 18/429,634

(22) Filed: Feb. 1, 2024

(30) Foreign Application Priority Data
May 23, 2023 (JP) 2023-084611

(51) Int. Cl. B60L 58/27; B60L 58/26

(52) U.S. Cl. CPC B60L 58/27; B60L 58/26; B60L 2240/545

(57) ABSTRACT

The power storage system includes a power storage device, a first heater and a second heater, and a control device. The first heater is disposed more away from the power storage device than the second heater. The control device is configured to be capable of executing first heating control for heating the power storage device using both the first heater and the second heater, and second heating control for heating the power storage device using only the second heater, among the first heater and the second heater. The control device executes the first heating control when a predetermined heating condition is met at start of charging of the power storage device. Further, the control device executes the second heating control instead of the first heating control when a predetermined switching condition is met during charging of the power storage device and during execution of the first heating control.

### CROSS-REFERENCE TO RELATED APPLICATION

This application claims priority to Japanese Patent Application No. 2023-084611 filed on May 23, 2023, incorporated herein by reference in its entirety.

### BACKGROUND

### 1. Technical Field

The present disclosure relates to a power storage system and a vehicle including the power storage system.

### 2. Description of Related Art

Japanese Unexamined Patent Application Publication No. 2020-113383 (JP 2020-113383 A) discloses a power storage system (more specifically, a charging system for a storage battery) that heats a storage battery using an electric heater provided around the storage battery. In this power storage system, the storage battery is heated not only by the electric heater but also by a charger provided around the storage battery by utilizing the fact that the charger generates heat through energization. In the power storage system described in JP 2020-113383 A, the storage battery is heated in order to increase the effective capacity of the storage battery of an electrified vehicle at the time of starting or charging the electrified vehicle.

### SUMMARY

In the technique described in JP 2020-113383 A, the amount of heat (heating amount) for heating the power storage device is increased by utilizing the heat generation of the charger, without increasing the number of electric heaters that are used to heat the power storage device. In such a technique, the power storage device is heated using the electric heater and the charger provided around the power storage device, and therefore the energy loss may be small. However, the amount of heating by the charger is smaller than the amount of heating by the electric heater. Therefore, a sufficient amount of heating is not necessarily obtained.

For example, when the power storage device is in a low-temperature state at the start of charging of the power storage device, the charging power is limited due to a decrease in the current that can be received by the power storage device, and the charging time of the power storage device (that is, the time required for the charging of the power storage device to be completed) may be prolonged. In order to shorten the charging time of the power storage device, it is required to raise the temperature of the power storage device in a low-temperature state to a sufficient temperature at an early stage at the start of charging of the power storage device. It is difficult to raise the temperature of the power storage device in a low-temperature state to a sufficient temperature at an early stage at the start of charging of the power storage device using the technique described in JP 2020-113383 A.

The present disclosure has been made in order to address the above issue, and an object thereof is to raise the temperature of a power storage device to a sufficient temperature at an early stage at the start of charging of the power storage device while suppressing a decrease in energy efficiency.

An aspect of the present disclosure provides a power storage system including: a power storage device; a first heater and a second heater configured to be capable of heating the power storage device using electric power; and a control device. The first heater is disposed more away from the power storage device than the second heater. The control device is configured to execute first heating control for heating the power storage device using both the first heater and the second heater, and second heating control for heating the power storage device using only the second heater, among the first heater and the second heater. The control device executes the first heating control when a predetermined heating condition is met at start of charging of the power storage device. The control device executes the second heating control instead of the first heating control when a predetermined switching condition is met during charging of the power storage device and during execution of the first heating control.

In a power storage system, a plurality of electric heaters is rarely arranged around a power storage device. However, there are many power storage systems in which one electric heater is disposed near a power storage device and another electric heater is disposed at a position away from the power storage device. Therefore, in the above configuration, the power storage device is heated using a plurality of electric heaters (first and second heaters). However, the amount of energy consumed for raising the temperature of the power storage device tends to be larger for the electric heater (first heater) located at a position more away from the power storage device than for the electric heater (second heater) located near the power storage device. A part of the energy (heat) generated at a position away from the power storage device is lost before being transferred to the power storage device. Therefore, it is considered that the heating of the power storage device by the second heater is more energy efficient than the heating of the power storage device by the first heater.

In this regard, the control device executes the first heating control when a predetermined heating condition is met at the start of charging of the power storage device. According to such control, the first heating control can be executed as necessary at the start of charging of the power storage device, which enables the first and second heaters to raise the temperature of the power storage device to a sufficient temperature at an early stage. The predetermined heating condition may be met when the amount of heating is insufficient with only the second heater.

Further, the control device switches from the first heating control to the second heating control when the predetermined switching condition is met. According to such control, the temperature of the power storage device can be adjusted (e.g., kept) through the second heating control after the temperature of the power storage device is raised to a sufficient temperature through the first heating control. The predetermined switching condition may be met when a sufficient amount of heating can be ensured with only the second heater. By switching from the first heating control to the second heating control, the heating of the power storage device by the first heater having relatively low energy efficiency is stopped, and only the heating of the power storage device by the second heater having relatively high energy efficiency is continued. Thus, a decrease in energy efficiency is suppressed.

According to the present disclosure, it is possible to raise the temperature of a power storage device to a sufficient temperature at an early stage at the start of charging of the power storage device while suppressing a decrease in energy efficiency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a vehicle according to an embodiment of the present disclosure;

FIG. 2 is a diagram showing a configuration around the power storage device shown in FIG. 1;

FIG. 3 is a flowchart illustrating charge control according to an embodiment of the present disclosure;

FIG. 4 is a diagram for describing the first and second heater controls and the first operation example of the power storage system according to the embodiment of the present disclosure;

FIG. 5 is a diagram illustrating a second operation example of the power storage system according to the embodiment of the present disclosure; and

FIG. 6 is a diagram illustrating a modified example and a third operation example of the process illustrated in FIG. 4.

### DETAILED DESCRIPTION OF EMBODIMENTS

An embodiment of the present disclosure will be described in detail with reference to the drawings. The same or corresponding parts in the drawings are designated by the same reference signs and repetitive description will be omitted.

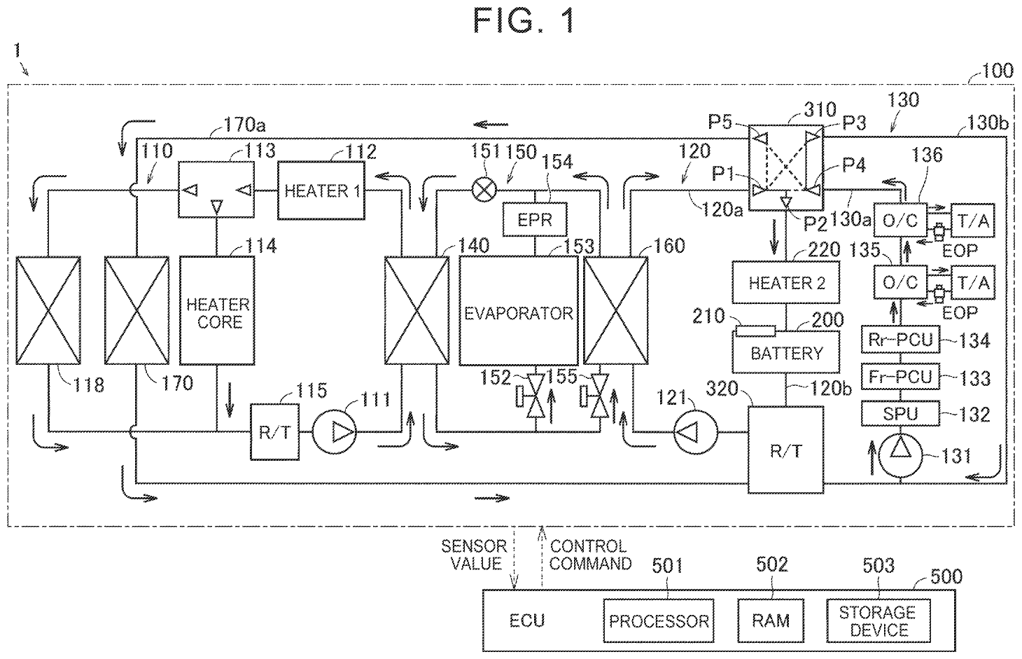

FIG. 1 is a diagram illustrating a schematic configuration of a vehicle

according to this embodiment. As illustrated in FIG. 1, the vehicle 1 is an electrified vehicle (xEV) equipped with the power storage system according to the present embodiment. The vehicle 1 is, for example, four-wheel BEV (battery electric vehicle). However, the vehicle 1 may be other electrified vehicles such as a plug-in hybrid electric vehicle. Further, the vehicle 1 may be configured to be capable of contactless charging. The number of wheels is also arbitrary, and may be three wheels or five wheels or more.

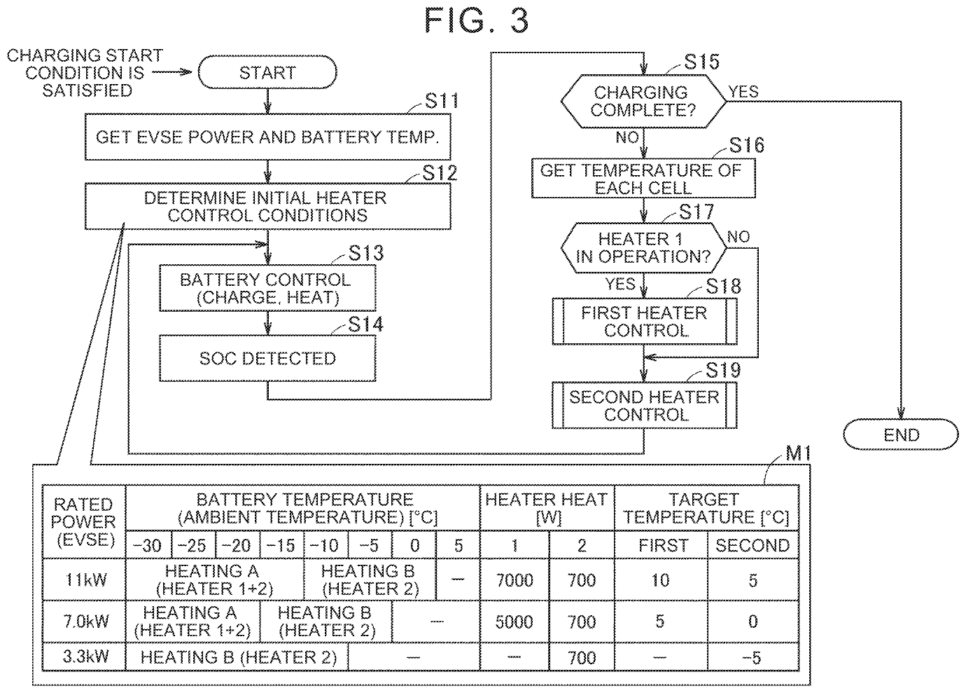

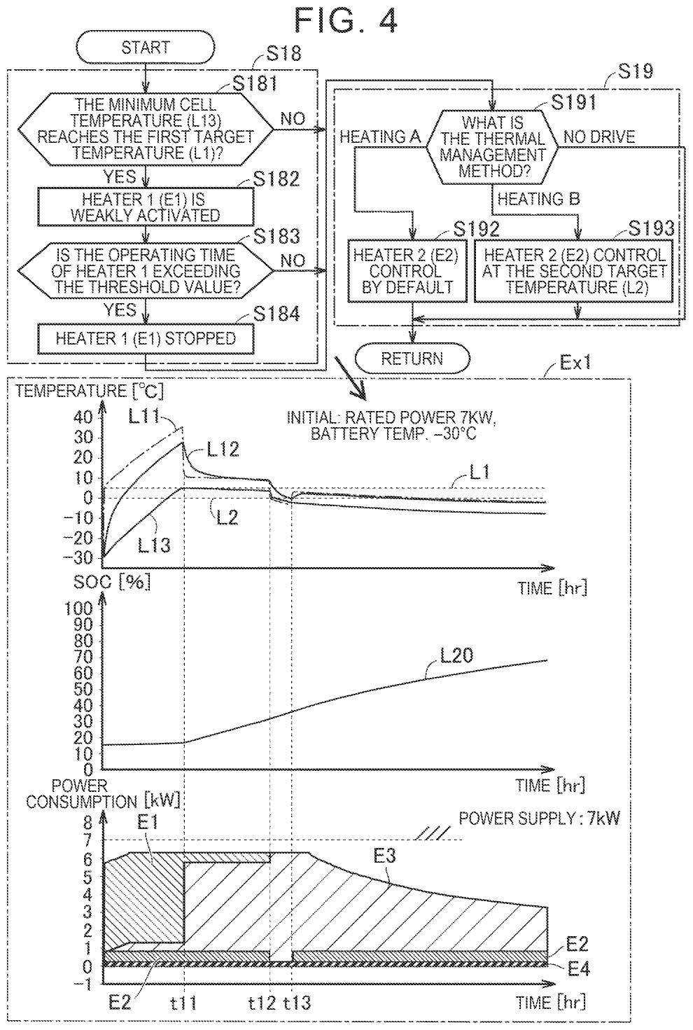

The vehicle 1 includes a thermal management circuit 100 and an electronic control unit (ECU) 500. ECU 500 includes a processor 501, a random access memory (RAM) 502, and a storage device 503. The processor 501 may be, for example, a central processing unit (CPU). The storage device 503 is configured to store stored information. In addition to the program, the storage device 503 stores information (a map, a mathematical expression, various parameters, and the like) used in the program. In this embodiment, the processor 501 executes a program stored in the storage device 503 to execute various kinds of control (for example, refer to FIGS. 3 and 4) in ECU 500. However, various kinds of control in ECU 500 may be executed by hardware (electronic circuitry) instead of software.

The thermal management circuit 100 is configured to perform thermal management of the vehicle I using a heat medium. The thermal management circuit 100 includes a first circuit 110, a second circuit 120, and a third circuit 130. The thermal management circuit 100 also includes a condenser 140, a refrigeration cycle 150, a chiller 160, a five-way valve 310, and a reservoir tank (R/T) 320. The five-way valve 310 and the reservoir tank 320 are shared by the second circuit 120 and the third circuit 130. The condenser 140, the refrigeration cycle 150, and the chiller 160 are disposed between the first circuit 110 and the second circuit 120, and function as an example of a “heat transfer mechanism” according to the present disclosure.

The first circuit 110 includes a first flow path through which the first heat medium flows. The first circuit 110 includes a pump 111, an electric heater 112 (first heater), a three-way valve 113, a heater core 114, and a reservoir tank (R/T) 115 and radiator 118. The three-way valve 113 switches the path of the first heat medium. The pump 111 circulates the first heat medium to the first circuit 110. Specifically, the pump 111 passes the first heat medium sucked up from the reservoir tank 115 in this order through the heater core 114 or the radiator 118 connected by the condenser 140, the electric heater 112, and the three-way valve 113, and then returns the first heat medium to the reservoir tank 115. The first heat medium exchanges heat with the respective devices during the passage. The pump 111, the electric heater 112, and the three-way valve 113 are controlled by an ECU 500. The radiator 118 functions as a heat exchanger. The radiator 118 exchanges heat between the first heat medium flowing through the first circuit 110 and the outside air.

The five-way valve 310 switches the path of the second heat medium. The five-way valve 310 comprises five ports P1 to P5. ECU 500 controls the five-way valve 310 so as to be one of the first to fifth connecting patterns described below. Hereinafter, the ports P1, P2, P3, P4, P5 may be simply referred to as “P1”, “P2”, “P3”, “P4”, and “P5”, respectively.

In the first connection pattern, P1 and P2 are connected, P3 and P4 are connected, and P5 is disconnected. In the second connection pattern, P1 and P2 are connected, P4 and P5 are connected, and P3 is disconnected. In the third connection pattern, P1 and P5 are connected, P3 and P4 are connected, and P2 is disconnected. In the fourth connection pattern, P2 and P4 are connected, P1 and P3 are connected, and P5 is disconnected. In the fifth connection pattern, P2 and P4 are connected, P1 and P5 are connected, and P3 is disconnected.

Flow paths 120a, 120b are connected to the ports P1, P2 of the five-way valve 310, respectively. The flow path 120a is a flow path connecting the port PI and the reservoir tank 320. The flow path 120b is a flow path connecting the port P2 and the reservoir tank 320. When P1 and P2 of the five-way valve 310 are connected (for example, first and second connection patterns), the second circuit 120 including the flow paths 120a and 120b is formed.

A pump 121 and a chiller 160, which will be described later, are disposed in the flow path 120a. A battery 200 and an electric heater 220 (second heater) are disposed in the flow path 120b. The pump 121 circulates the second heat medium to the second circuit 120. Specifically, the pump 121 passes the second heat medium sucked up from the reservoir tank 320 through the chiller 160, the five-way valve 310, the electric heater 220, and the battery 200 in this order, and then returns the second heat medium to the reservoir tank 320.

The second heat medium exchanges heat with the respective devices during the passage. A second heat medium that exchanges heat with the battery 200 flows through the flow path 120b. The pump 121 and the electric heater 220 are controlled by an ECU 500. The battery 200 is provided with battery management system (BMS) 210 for monitoring the status of the battery 200.

Flow paths 130b, 130a are connected to the ports P3, P4 of the five-way valve 310, respectively. Flow paths 130b, 130a are flow paths connecting the ports P3, P4 and the reservoir tank 320, respectively. P3 and P4 of the five-way valve 310 are connected to each other (for example, the first and third connection patterns) to form the third circuit 130 including the flow paths 130a and 130b.

In this embodiment, the same type of heat medium (second heat medium) as the heat medium circulating in the second circuit 120 circulates in the third circuit 130. The first heat medium circulating in the first circuit 110 is a different type of heat medium from the second heat medium. The third heat medium used in the refrigeration cycle 150, which will be described later, is also a different type of heat medium from the first and second heat media. For example, the first heating medium may be a known heating medium for heating. The second heating medium may be an insulating oil or an antifreeze. The third heat medium may be a known heat medium for a refrigeration cycle. However, the present disclosure is not limited thereto, and each of the first to third heat media can be appropriately changed.

In the flow path 130a, a pump 131, smart power unit (SPU) 132, a front motor PCU (Fr-PCU) 133, a rear motor PCU (Rr-PCU) 134, and oil coolers (O/C) 135, 136 are arranged. The pump 131 circulates the second heat medium to the third circuit 130. Specifically, the pump 131 passes the second heat medium sucked up from the reservoir tank 320 through SPU 132, Fr-PCU 133, Rr-PCU 134, the oil cooler 135, the oil cooler 136, and the five-way valve 310 in this order, and then returns the second heat medium to the reservoir tank 320. The second heat medium exchanges heat with the respective devices during the passage. SPU 132 functions as an in-vehicle charger/discharger (charger and discharger) of the battery 200. However, it is not essential that the vehicle 1 has an external power supply function (for example, a V2H function). SPU 132 includes, for example, power converting circuitry. PCU means “Power Control Unit”. Each of Fr-PCU 133 and Rr-PCU 134 drives a MG (motor generator) (not shown) using electric power supplied from the battery 200. The torque outputted by MG rotates the drive wheels of the vehicle 1 via a T/A. The battery 200 functions as a traveling power storage device. PCU may include bi-directional inverters. SPU 132 and the respective PCU are controlled by ECU 500. T/A functions as a power transmission. Each of the oil coolers 135, 136 cools the oil supplied to T/A of the vehicle 1 by an electric oil pump (EOP). The second heat medium flowing through the oil coolers 135, 136 exchanges heat with oil for T/A. One or more temperature sensors for detecting the temperature of the second heat medium flowing through the flow path 130a may be provided in a predetermined portion (for example, in the vicinity of the respective PCU).

A flow path 170a is connected to a port P5 of the five-way valve 310. The flow path 170a is a flow path connecting the port P5 and the reservoir tank 320. A radiator 170 is provided in the flow path 170a. The radiator 170 functions as a heat exchanger. The radiator 170 exchanges heat between the heat medium flowing through the flow path 170a and the outside air. ECU 500 can cool the second heat medium by exchanging heat in the radiator 170 by connecting the flow path 120a or 130a to the flow path 170a by the five-way valve 310.

The third heat medium circulates in the refrigeration cycle 150. The refrigeration cycle 150 includes a compressor 151, an electric expansion valve 152, an evaporator 153, an evaporative pressure-regulating valve (evaporative pressure regulator: EPR) 154, and an electric expansion valve 155. The condenser 140 is connected to both the first circuit 110 and the refrigeration cycle 150, and functions as a heat exchanger. The condenser 140 exchanges heat between the first heat medium flowing through the first circuit 110 and the third heat medium circulating in the refrigeration cycle 150. The chiller 160 is connected to both the refrigeration cycle 150 and the flow path 120a, and functions as a heat-exchanger. When the five-way valve 310 is in the first or second connection pattern, the chiller 160 exchanges heat between the third heat medium circulating in the refrigeration cycle 150 and the second heat medium flowing in the second circuit 120. As described above, the condenser 140, the refrigeration cycle 150, and the chiller 160 are configured to perform heat transfer between the first heat medium flowing through the first circuit 110 and the second heat medium flowing through the second circuit 120. Refrigeration cycle 150 (including compressor 151 and various valves) is controlled by ECU 500. One or more pressure sensors and one or more temperature sensors that respectively detect the pressure and the temperature of the third heat medium flowing through the refrigeration cycle 150 may be provided at a predetermined site.

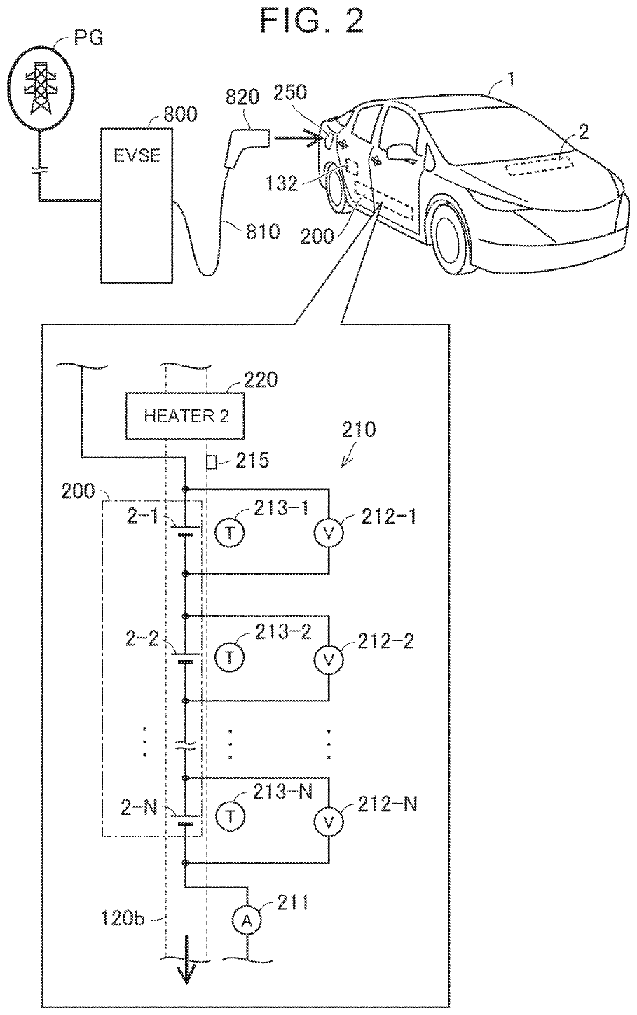

FIG. 2 is a diagram illustrating a configuration of the battery 200 and BMS 210. Referring to FIG. 2, the battery 200 is a battery pack configured by connecting N cells 2-1 to 2-N. N is a natural number of 2 or more, and may be 2 or more and less than 100 or 100 or more. The cells 2-1 to 2-N are connected in series. However, the connection mode of the cells in the assembled battery is not limited to series, and may include parallel connection. The electric heater 220 is disposed in the vicinity of the battery 200 and is configured to heat the second thermal medium flowing through the flow path 120b.

BMS 210 includes a current sensor 211 that detects a current flowing through the battery 200 (assembled battery), voltage sensors 212-1 to 212-N and temperature sensors 213-1 to 213-N corresponding to the cells 2-1 to 2-N, respectively, and a temperature sensor 215 that detects an ambient temperature of the battery 200. The temperature sensor 215 detects the temperature of the second heat medium flowing through the flow path 120b in the vicinity of the battery 200. Detected by the sensors are inputted into ECU 500.

ECU 500 can obtain the current of the battery 200, the ambient temperature of the battery 200, and the voltage and temperature of each cell of the battery 200 based on the signals from the respective sensors. In addition, ECU 500 can calculate state of charge (SOC) for each cell from the detected data by the respective sensors. SOC represents the ratio of the present amount of stored electricity to the amount of stored electricity in a fully charged state, for example, in the range of 0 to 100%. The configuration of BMS 210 can be changed as appropriate.

The vehicle 1 includes an inlet 250. The inlet 250 functions as a charging port. Electric vehicle supply equipment (EVSE) 800 comprises a charging cable 810 extending outwardly from the body of EVSE 800. The inlet 250 is configured such that the connector 820 (distal end portion) of the charging cable 810 can be detachably attached. When the connector 820 of the charging cable 810 connected to the main body of EVSE 800 is connected to the inlet 250 of the vehicle 1 in the parked state, the vehicle 1 is electrically connected to EVSE 800 (plug-in state). EVSE 800 and the power system PG are electrically connected to each other. Therefore, the vehicle 1 in the plug-in status is electrically connected to the power system PG. The power system PG is a power grid constructed by a transmission and distribution facility. A plurality of power plants is connected to the power system PG.

When the vehicle 1 in the plug-in status performs external charging (charging of the battery 200 by electric power from the outside of the vehicle), electric power supplied from the power system PG is inputted to the inlet 250 via EVSE 800. SPU 132 uses the power input to the inlet 250 to generate charging power according to an instruction from ECU 500, and inputs the generated charging power to the battery 200. EVSE 800 supplies, for example, AC power to the inlet 250. SPU 132 may perform AC/DC transformation and transformation to generate charge power. However, EVSE 800 power supply system is not limited to AC system, and may be a DC system.

The air conditioning device 2 mounted on the vehicle 1 performs air conditioning (heating and cooling) inside the vehicle 1 using the first circuit 110 and the refrigeration cycle 150. The electric heater 112 heats the first heating medium in the first circuit 110 in accordance with a command from ECU 500. The heater core 114 heats the air in the vehicle cabin by heat exchange with the first heat medium. In addition, the evaporator 153 of the refrigeration cycle 150 cools the air in the vehicle cabin.

The battery 200 supplies power to various devices included in the thermal management circuit 100 shown in FIG. 1. The battery 200 may provide power to the electric heater 112 via first power converters (e.g., DC/DC converters) (not shown). The battery 200 may provide power to the electric heater 220 via second power converters (e.g., DC/DC converters) (not shown). In this embodiment, the driving voltage of the electric heater 112 is higher than the driving voltage of the electric heater 220. The maximum heating value of the electric heater 112 is larger than that of the electric heater 220. The electric heater 112 consumes more energy during maximum heat generation than the electric heater 220. Note that at least one of the various devices included in the thermal management circuit 100 may be supplied with electric power from an in-vehicle battery (for example, an auxiliary battery (not shown)) other than the battery 200.

FIG. 3 is a flow chart illustrating a process related to charge control

executed by ECU 500. Each step in the flowchart is denoted as “S”. The process illustrated in this flowchart is started, for example, when the start condition of the external charging (plug-in charging) is satisfied. Specifically, when the vehicle 1 is in the plug-in state (see FIG. 2), the condition for starting the external charge may be satisfied, and the following process flow (S11 to S19) may be started. However, if a failure in the thermal management circuit 100 is detected as a result of the failure diagnosis by ECU 500, the external charge may not be started.

Referring to FIG. 3, in S11, an ECU 500 acquires EVSE information indicating a specification of a power supply facility (for example, an EVSE 800) connected to the vehicle 1 and battery temperature information indicating a present temperature of the battery 200. EVSE information includes information indicating an output performance (for example, a rated output) of the power supply facility. The rated output corresponds to the maximum power (KW) that can be output by the specified power supply equipment. ECU 500 may receive EVSE from the power supply facility by communicating with the power supply facility connected to the vehicle 1. The battery temperature data includes an ambient temperature (temperature of the second heat medium) of the battery 200 detected by BMS 210. Hereinafter, the rated output of the power supply facility acquired by S11 is also referred to as “EVSE output”. The ambient temperature of the battery 200 acquired by S11 is also referred to as “battery temperature”.

In S12, ECU 500 determines an initial-heater-control-condition based on the data acquired by S11. Specifically, the storage device 503 stores the map MI in advance. When EVSE power and the battery power are input, the map Ml outputs a heater control signal corresponding to the input power. The heater control condition includes identification information of the heater to be driven, a driving amount (heating value) of the heater, and a target temperature used in the heater control. The heater driven during external charging of the battery 200 is at least one of the electric heaters 112 and 220. Specifically, ECU 500 performs one of a first heating control (referred to as “heating A” in the map M1) for heating the battery 200 using both the electric heaters 112 and 220 during external charging of the battery 200, and a second heating control (referred to as “heating B” in the map M1) for heating the battery 200 using only the electric heater 220 among the electric heaters 112 and 220, as needed. In addition, ECU 500 may employ “no heater drive” during external charging of the battery 200 (i.e., neither of the electric heaters 112 and 220 are driven) (referred to as “_” in the map M1). Hereinafter, the initial heater control condition may be simply referred to as an “initial condition”.

The map M1 shown in FIG. 3 respectively define an initial-condition suitable when EVSE power is 3.3 kW, 7 kW, 11 kW. For each of EVSE powers 11 kW, 7 kW, a “no heater drive” is defined as an initial condition when the battery temperature is greater than or equal to the first threshold, a second heating control is defined as an initial condition when the battery temperature is greater than or equal to the second threshold and less than the first threshold, and a first heating control is defined as an initial condition when the battery temperature is less than the second threshold. However, the first threshold (e.g., 5° C.) and the second threshold (e.g., −10° C.) at EVSE power 11 kW are higher than the first threshold (e.g., 0° C.) and the second threshold (e.g., −15° C.) at EVSE power 7 kW, respectively. Further, with respect to the rated power 3.3 kW, the “no heater drive” is determined when the battery temperature is equal to or higher than a predetermined value (for example, −5° C.), and the second heating control is determined as the initial condition when the battery temperature is lower than the predetermined value.

The amount of heat generated by the electric heater 220 in the initial-state is the same (e.g., 700 W) in any of EVSE power 11 kW, 7 KW, 3.3 kW. With respect to the amount of heat generated by the electric heater 112 in the initial-state, the value of EVSE power 11 kW (for example, 7000 W) is higher than the value of EVSE power 7 KW (for example, 5000 W). With respect to the first heating control, the heating value of the electric heater 112 may be set to 5 times or more of the heating value of the electric heater 220.

Target temp. in heater-control becomes higher as EVSE power becomes larger. The first target temperature for the first heat control is, for example, 10° C. and 5° C. for EVSE power 11 kW, 7 KW, respectively. The second target temperatures for the second heat control are, for example, 5° C., 0° C., and-5° C., respectively, with respect to EVSE power 11 kW, 7 KW, 3.3 kW. Each target temperature may be predetermined based on a temperature characteristic of the chargeable power of the battery 200. In the low-temperature region below the temperature of 0° C., the chargeable power of the battery 200 increases as the temperature of the battery 200 increases. In this embodiment, the second target temperature is lower than the first target temperature.

As described above, according to the map M1 shown in FIG. 3, as EVSE power increases, the number of heaters to be driven increases, the driving amount of the heaters increases, and the target temperature increases. In S12, ECU 500 uses such a map M1 to determine EVSE power obtained in S11 and the initial-condition as a function of the battery temperature. If the rated output of the feed installation connected to the vehicle 1 does not correspond to any of 3.3 kW, 7 KW, 11 KW, ECU 500 may adopt an initial-condition corresponding to the closest rated output (any of 3.3 kW, 7 KW, 11 KW).

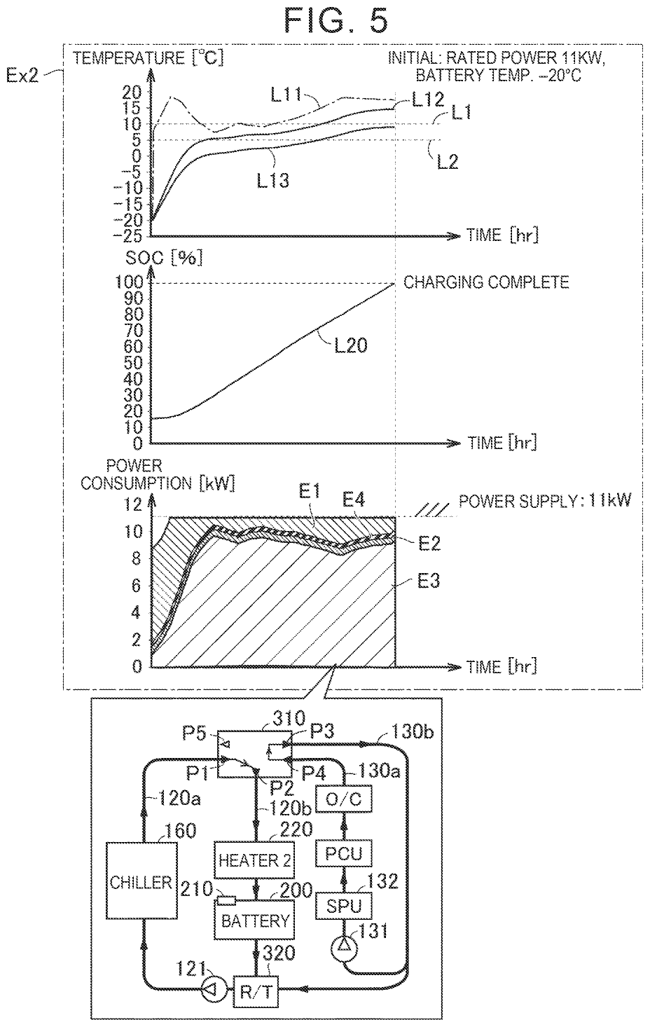

In a subsequent S13, ECU 500 performs external charging of the battery 200 while performing thermal management (without first heating control, second heating control, or heater driving) of the battery 200 according to the initial conditions determined in S12. In this embodiment, ECU 500 drives the pumps 111, 121, 131 with the five-way valve 310 in the first connecting pattern (sec, e.g., FIG. 5) to control the electric heaters 112 and 220 at S12 determined conditions. For example, in the first heating control, heat generated by the electric heater 112 is transmitted to the battery 200 via the first heating medium, the condenser 140, the third heating medium (refrigeration cycle 150), the chiller 160, and the second heating medium, and heat generated by the electric heater 220 is transmitted to the battery 200 via the second heating medium. Accordingly, the temperature of the battery 200 increases. In addition, ECU 500 controls SPU 132 so that the battery 200 is charged by the electric power supplied from the power supply facility outside the vehicle. Accordingly, SOC of the battery 200 increases.

In a subsequent S14, ECU 500 obtains SOC of the present battery 200 detected by BMS 210. Subsequently, in S15, ECU 500 determines whether or not to terminate the charging based on whether or not the charging termination condition is satisfied. The charge termination condition is satisfied, for example, when SOC of the battery 200 reaches the target value. The target value may be 100% (SOC value indicating full charge). Note that the charging end condition can be changed as appropriate.

When the charge-end condition is not satisfied (NO in S15), the process proceeds to S16. In S16, ECU 500 obtains the temperature of each cell of the present battery 200 detected by BMS 210. Hereinafter, the highest cell temperature and the lowest cell temperature among the temperatures of the respective cells obtained by S16 are referred to as “maximum cell temperature” and “lowest cell temperature”.

In a subsequent S17, ECU 500 determines whether or not the electric heater 112 is in operation. When the first heat control is executed in S13, it is determined that S17 is YES, and the process proceeds to S18. On the other hand, when the first heat control is not executed in S13, it is determined as NO in S17, and the process proceeds to S19. FIG. 4 is a diagram for describing a S18 and a S19. The first heater-control (S18) includes S181 to S184. The second heater control (S19) includes S191 to S193.

Referring to FIG. 4, in the first heater control (S18), ECU 500 determines whether or not the minimum cell temperature (S16 in FIG. 3) has become equal to or higher than the first target temperature (initial-condition) in S181. If the minimum cell temperature is less than the first target temperature (NO in S181), the process proceeds to S19 while the electric heater 112 remains operating at the initial conditions. In this case, the first heating control is continued. On the other hand, when the minimum cell temperature is equal to or higher than the first target temperature (YES in S181), ECU 500 controls the electric heater 112 so that the electric heater 112 operates (weakly operates) at a S182 with a lower heating value than the initial condition. Thereafter, the process proceeds to S183.

In S183, ECU 500 determines whether the operating time of the electric heater 112 (elapsed time from the beginning of operation) exceeds a predetermined threshold. The threshold value may be a limit value (allowable operation time) determined according to the component durability of the electric heater 112. If the activation time of the electric heater 112 does not exceed the above threshold (NO in S183), the process proceeds to S19 with the electric heater 112 in a weak activation (S182). In this case, the first heating control is continued. On the other hand, if the operating time of the electric heater 112 exceeds the above threshold (YES in S183), ECU 500 shuts down the electric heater 112 at S184. Thus, switching from the first heating control to the second heating control is performed. Thereafter, the process proceeds to S19.

In the second heater control (S19), ECU 500 determines in S191 whether the thermal management is performed in the first heating control, the second heating control, or without the heater drive. If it is determined in S191 that “no heater-drive” has occurred (default), the process returns to S13 of FIG. 3. When S191 determines “first heat control”, ECU 500 controls the electric heater 220 in S192 with the heat generation value (fixed condition) in the initial condition. Thereafter, the process returns to S13 of FIG. 3, and ECU 500 performs external charging of the battery 200 together with the first heating control according to the condition determined by S18, S19. When S191 determines “second heat control”, ECU 500 controls the electric heater 220 based on the maximum cell temperature (S16 in FIG. 3) and the second target temperature (initial-condition) in S193. Thereafter, the process returns to S13 of FIG. 3, and ECU 500 performs external charging of the battery 200 together with the second heating control according to the condition determined by S193.

In FIG. 4, the time chart Ex1 shows a state transition (first operation example) when the first and second heaters are controlled under the initial conditions corresponding to EVSE power “7 kW” and the battery temperature “−30° C.”. In the time chart Ex1, the lines L1, L2, L11, L12, L13, L20 indicate a first target temperature, a second target temperature, a battery temperature, a maximum cell temperature, a minimum cell temperature, and a SOC, respectively. The area E1, E2, E3, E4 indicates the amount of electric power consumed by the driving of the electric heater 112, the driving of the electric heater 220, the charging of the battery 200, and the energy-loss (heat dissipation, etc.) among the electric power supplied from the power supply facility to the vehicle 1. “t” in the time chart means timing.

In the time chart Ex1, the first heating control is executed according to the initial condition. Thereafter, in t11, the lowest cell temperature (line L13) reaches the first target temperature (line L1), and the electric heater 112 is weakly activated. At t12, the activation time of the electric heater 112 exceeds the threshold and the electric heater 112 is deactivated. Thus, the second heating control is executed instead of the first heating control. Further, since the maximum cell temperature (line L12) is higher than the second target temperature (line L2), ECU 500 brings the electric heater 220 into a dormant state (substantially stopped state). Then, at t13, ECU 500 reactivates the electric heater 220 to keep the maximum cell temperature at the second target temperature.

Referring back to FIG. 3, in S13, thermal management and external charging of the battery 200 are performed. When the charge termination condition is satisfied (YES in S15), the series of processes illustrated in FIG. 3 ends. FIG. 5 is a diagram illustrating a second operation example of the power storage system according to the embodiment. The time chart Ex2 shows the state transition (second operation example) when the first and second heater controls shown in FIGS. 3 and 4 are executed under the initial conditions corresponding to EVSE power “11 kW” and the battery temperature “−20° C.”. Lines and regions in the time chart Ex2 shown in FIG. 5 conform to the time chart Ex1 shown in FIG. 4. In the time chart Ex2, the first heating control is executed according to the initial condition. As shown in FIG. 5, ECU 500 performs thermal management and external charge (S13 in FIG. 3) of the battery 200 with the five-way valve 310 in the first connecting pattern. During the execution of the first heating control, the charging end condition is satisfied without the switching condition being satisfied. As a result, the thermal management and the external charging of the battery 200 are completed.

As described above, the thermal management method according to this embodiment includes the respective processes illustrated in FIGS. 3 and 4. The power storage system according to this embodiment includes a power storage device (battery 200), a first heater (electric heater 112) and a second heater (electric heater 220) configured to be able to heat the power storage device using electric power, and a control device (ECU 500).

The electric heater 112 is disposed further away from the battery 200 than the electric heater 220. ECU 500 executes the first heating control when a predetermined heating condition is satisfied when the battery 200 starts charging. When the predetermined switching condition is satisfied during the charge of the battery 200 and the execution of the first heating control, ECU 500 executes the second heating control instead of the first heating control.

Heating the battery 200 by the electric heater 220 is more energy efficient than heating the battery 200 by the electric heater 112. According to the above-described control, the first heating control can be executed as necessary at the start of charging of the battery 200, and the temperature of the battery 200 can be raised to a sufficient temperature at an early stage by the electric heaters 112 and 220. Further, according to the above control, after the temperature of the battery 200 is raised to a sufficient temperature by the first heating control, the electric heater 112 is stopped, and the temperature of the battery 200 can be adjusted by the second heating control (for example, heat insulation). Thus, a decrease in energy efficiency is suppressed.

In this embodiment, ECU 500 controls the amount of heating by the electric heater 112 based on the temperature of the battery 200 during the execution of the first heating control (S181, S182 in FIG. 4). Then, when a predetermined period of time has elapsed since the first heating control was started (YES in S183 of FIG. 4), the predetermined switching condition is satisfied. According to such a configuration, it is easy to control the amount of heating by the electric heater 112 to an appropriate amount (an amount necessary and sufficient for raising the temperature of the battery 200) during execution of the first heating control. Further, if the first heating control is continued for a long time, the energy efficiency may deteriorate. In this regard, in the above-described configuration, ECU 500 switches from the first heating control to the second heating control at a timing when a predetermined time has elapsed since the first heating control is started. Thus, a decrease in energy efficiency is suppressed.

The vehicle 1 illustrated in FIGS. 1 and 2 includes a first flow path (first circuit 110) through which a first heat medium flows, an air conditioning device 2 that performs air conditioning inside the vehicle 1 by heat exchange with the first heat medium, a second flow path (flow path 120b) through which a second heat medium that performs heat exchange with the battery 200 flows, and a heat transfer mechanism (condenser 140, refrigeration cycle 150, chiller 160) that performs heat transfer between the first heat medium and the second heat medium. The electric heater 112 is provided in the first flow path. The electric heater 220 is provided in the second flow path. In such a configuration, the heat management of the vehicle I can be suitably performed by the first flow path (the first heat medium), the second flow path (the second heat medium), and the heat transfer mechanism. Further, since the electric heater 112 for the air conditioning device 2 is used for heating the battery 200, it is not necessary to add a dedicated electric heater for heating the battery 200.

Further, ECU 500 of the vehicle 1 determines whether or not the predetermined heating-condition is satisfied by using the output performance (for example, the rated output) of the power supply facility and the temperature of the second heating medium when the battery 200 starts charging using the power supply facility (for example, EVSE 800). Specifically, the map MI shown in FIG. 3 defines the heating-conditions. According to such a configuration, it is easy to accurately determine whether or not it is necessary to execute the first heating control that consumes more energy than the second heating control at the start of charging of the battery 200. The temperature of the second heat medium corresponds to the ambient temperature of the battery 200. If the output performance of the feed facility is lower than the rated output, such as due to a disaster (e.g., lightning strike) or a generator fault, ECU 500 may obtain the latest output performance of the feed facility (e.g., maximal output) and use the latest output performance instead of the rated output.

Each of the heating conditions and the switching conditions described above can be changed as appropriate. The processing flows shown in FIGS. 3 and 4 can be changed as appropriate. For example, the order of processing may be changed, or unnecessary steps may be omitted, depending on the purpose. Further, the content of any of the processes may be changed.

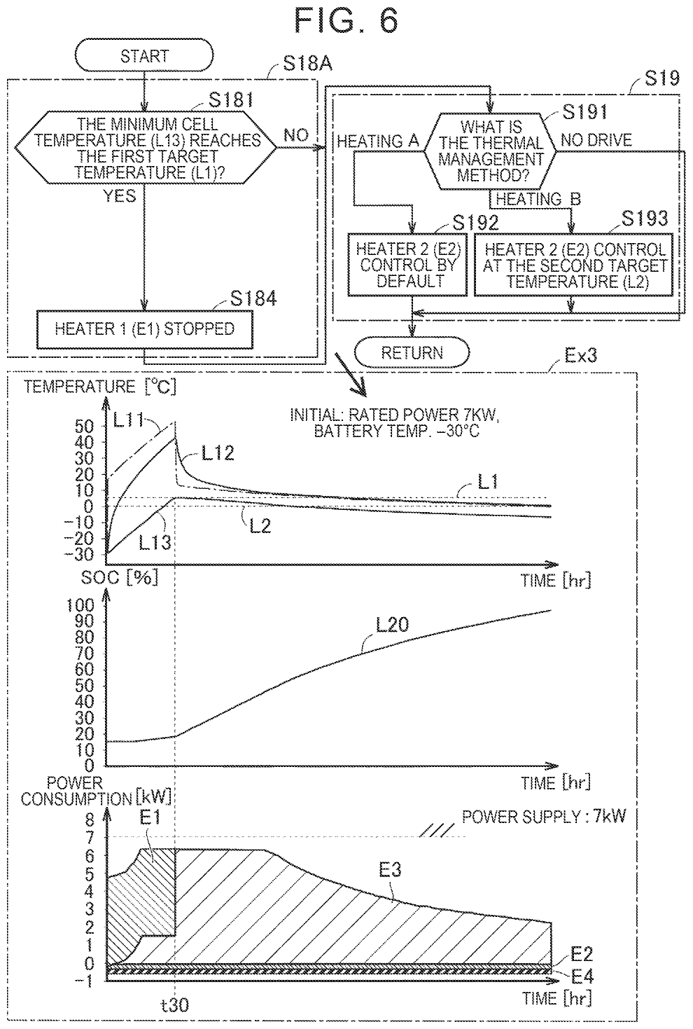

FIG. 6 is a diagram illustrating a modification of the process illustrated in FIG. 4. Lines and regions in the time chart Ex3 (third exemplary operation) shown in FIG. 6 conform to the time chart Ex shown in FIG. 4. In S18A shown in FIGS. 6, S182 and S183 in the process shown in FIG. 4 are omitted. In the time chart Ex3, the first heating control is executed according to the initial condition, and the lowest cell temperature (line L13) reaches the first target temperature (line L1) in t30 (YES in S181). As a result, the switching condition is satisfied, and the electric heater 112 is stopped in S184. In the second heating control, the electric heater 220 is controlled such that ECU 500 brings the maximum cell temperature (line L12) closer to the second target temperature (line L2) (S193).

The power storage system according to the modification includes a cell temperature sensor (temperature sensors 213-1 to 213-N shown in FIG. 2) that detects the cell temperature of each of the plurality of cells included in the battery 200 (assembled battery). When the lowest cell temperature in the battery 200 becomes equal to or higher than the predetermined temperature during the charge of the battery 200 and the first heat control (YES in S181), the above-described switching condition is satisfied. Therefore, it is possible to raise the temperature of all the cells included in the assembled battery to a predetermined temperature (for example, a temperature at which charging of the cells is appropriately performed) at an early stage.

The embodiment disclosed herein should be considered as illustrative and not restrictive in all respects. The scope of the present disclosure is shown by the claims, rather than the above embodiments, and is intended to include all modifications within the meaning and the scope equivalent to those of the claims.

What is claimed is:

1. A power storage system comprising:
a power storage device;
a first heater and a second heater configured to be capable of heating the power storage device using electric power; and
a control device, wherein:
the first heater is disposed more away from the power storage device than the second heater;
the control device is configured to be capable of executing
first heating control for heating the power storage device using both the first heater and the second heater, and
second heating control for heating the power storage device using only the second heater, among the first heater and the second heater; and
the control device executes the first heating control when a predetermined heating condition is met at start of charging of the power storage device, and executes the second heating control instead of the first heating control when a predetermined switching condition is met during charging of the power storage device and during execution of the first heating control.

2. The power storage system according to claim 1, wherein:
the control device controls an amount of heating by the first heater based on a temperature of the power storage device during execution of the first heating control; and
the predetermined switching condition is met when a predetermined time has elapsed since start of the first heating control.

3. The power storage system according to claim 1, wherein:
the power storage device is an assembled battery constituted by connecting a plurality of cells;
the power storage system further includes a cell temperature sensor that detects a cell temperature of each of the cells included in the assembled battery; and
the predetermined switching condition is met when the cell temperature that is lowest in the assembled battery becomes equal to or higher than a predetermined temperature during charging of the power storage device and during execution of the first heating control.

4. A vehicle comprising the power storage system according to claim 1, wherein:
the vehicle further includes
a first flow path through which a first heat medium flows,
an air conditioning device that performs air conditioning inside the vehicle through heat exchange with the first heat medium,
a second flow path through which a second heat medium for performing heat exchange with the power storage device flows, and
a heat transfer mechanism that performs heat transfer between the first heat medium and the second heat medium;
the first heater is provided in the first flow path; and
the second heater is provided in the second flow path.

5. The vehicle according to claim 4, wherein:
charging of the power storage device is charging of the power storage device by power supplied from power supply equipment outside the vehicle; and
the control device determines whether the predetermined heating condition is met using output performance of the power supply equipment and a temperature of the second heat medium at start of charging of the power storage device using the power supply equipment.
